(19) United States
(12) Patent Application Publication
(10) Pub. No.: US 2009/0216532 A1
(43) Pub. Date: Aug. 27, 2009

(54) Automatic Extraction and Dissemination of Audio Impression

(75) Inventors: Peter White, Oaks, TX (US); Robert Fleming, Lynnfield, MA (US); Paul Jenkins, Plano, TX (US)

Correspondence Address: BROMBERG & SUNSTEIN LLP, 125 SUMMER STREET, BOSTON, MA, 02110-1618, US

(73) Assignee: NUANCE COMMUNICATIONS, INC., Burlington, MA (US)

(21) Appl. No.: 12/239,020

(22) Filed: Sep. 26, 2008

Related U.S. Application Data
(60) Provisional application No. 60/975,326, filed on Sep. 26, 2007.

(51) Int. Cl. G10L 15/26

(52) U.S. Cl. 704/235; 704/E15.043

(57) ABSTRACT

A method of creating a voice message is described. A dictated audio input is converted by automatic speech recognition to produce a structured text report that includes report fields with report field data extracted from the dictated audio input. A report message is created for transmission over an electronic communication system to a message recipient. The report message has message fields with message field data based on corresponding report field data. A message audio extract is automatically extracted from a portion of the dictated audio input and attached to the report message. And the report message with the message audio extract attachment is forwarded over the electronic communication system to the message recipient

This application claims priority from U.S. Provisional Patent Application 60/975,326, filed Sep. 26, 2007, which is incorporated herein by reference.

### FIELD OF THE INVENTION

The present invention relates to processing of structured documents, and more specifically, to automatic extraction of audio report sections.

### BACKGROUND ART

Automatic speech recognition is useful in creating structured text reports such as patient medical reports. For example, the PowerScribe® WorkStation product marketed by Dictaphone Healthcare Solutions of Nuance Communications, Inc. is widely used for the creation of patient radiology reports. FIG. 1 shows an example of the user interface presented by PowerScribe. Once the dictated audio input has been converted into representative text, the audio is stored temporarily for reference, then eventually purged.

Once created, such text reports are then communicated from the report creator to various organizational recipients. For example, patient medical reports are communicated from a diagnostic clinician to an ordering clinician via facsimile by a medical communication system. The Veriphy™ product marketed by Vocada, Inc. provides voice message communications of medical reports. U.S. Pat. No. 6,778,644 (hereby incorporated by reference) describes some aspects of such a voice message communications system.

### SUMMARY OF THE INVENTION

Embodiments of the present invention are directed to creating a voice message. A dictated audio input is converted by automatic speech recognition to produce a structured text report which includes report fields with report field data extracted from the dictated audio input. A report message is created for transmission over an electronic communication system to a message recipient. The report message includes message fields with message field data based on corresponding report field data. A message audio extract is automatically extracted from a portion of the dictated audio input and attached to the report message. And the report message with the message audio extract attachment is forwarded over the electronic communication system to the message recipient.

In further specific embodiments, the message audio extract corresponds to a summary section of the structured text report such as an impression section of a radiography report. Similarly, the structured text report may be a patient medical report such as a patient radiography report. One of the message fields may be a message category that characterizes a report type associated with the report message. The automatic extraction of the message audio extract may be based on user configurable settings. The report message may be created in response to a spoken command input or a selection from a visual display.

Embodiments also include a computer program product in a computer readable storage medium for creating a voice message. The computer program product includes program code for converting a dictated audio input by automatic speech recognition to produce a structured text report that includes report fields with report field data extracted from the dictated audio input; program code for creating a report message for transmission over an electronic communication system to a message recipient, the report message including message fields with message field data based on corresponding report field data; program code for attaching to the report message a message audio extract that is automatically extracted from a portion of the dictated audio input; and program code for forwarding the report message with the message audio extract attachment over the electronic communication system to the message recipient.

In further such embodiments, the message audio extract corresponds to a summary section of the structured text report such as an impression section of a radiography report. Similarly, structured text report may be a patient medical report such as a patient radiography report. One of the message fields may be a message category that characterizes a report type associated with the report message. The automatic extraction of the message audio extract may be based on user configurable settings. The program code for creating a report message may be responsive to a spoken command input or to a selection from a visual display.

### BRIEF DESCRIPTION OF THE DRAWINGS

FIG. 1 shows example of a user interface according to the prior art.

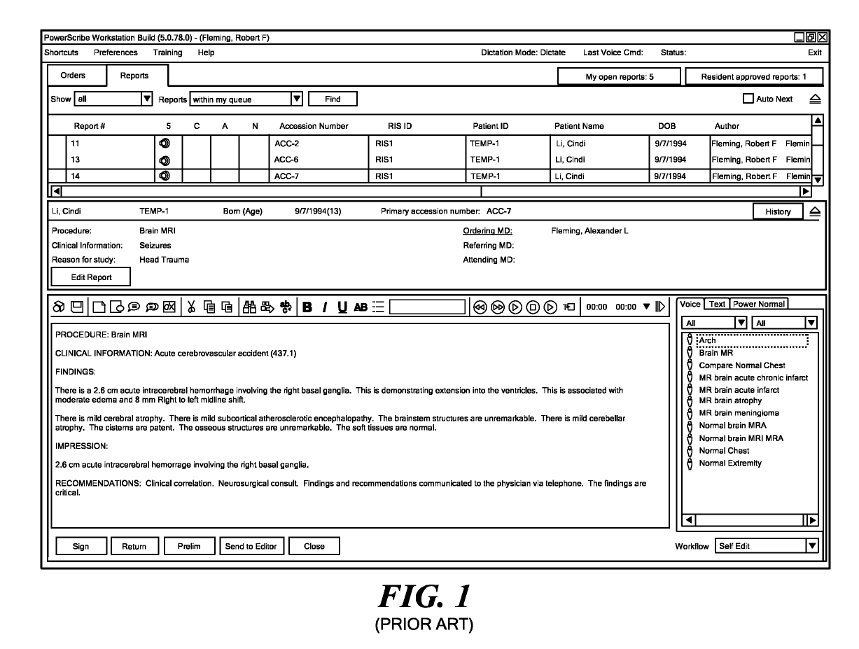

FIG. 2 shows various steps in creating a voice message according to one embodiment of the present invention.

### DETAILED DESCRIPTION OF SPECIFIC EMBODIMENTS

Embodiments of the present invention are directed to automatic extraction of a portion of the audio input in applications where a dictated audio input is converted by automatic speech recognition to produce a structured text report that has report fields with report field data extracted from the dictated audio input. The extracted audio is attached to a report message that also has message fields with message field data based on corresponding report field data.

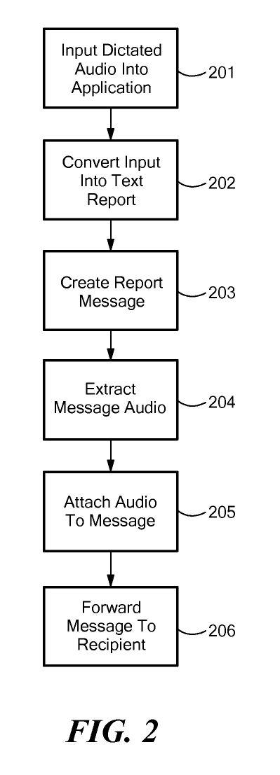

FIG. 2 shows various steps in creating a voice message according to one embodiment of the present invention. Initially, an application user provides a dictated audio input to a report creation application, step 201. The report creation application converts the dictated audio input by automatic speech recognition, step 202, to produce a structured text report that includes report fields with report field data extracted from the dictated audio input. For example, the application user may be a reporting medical clinician, the report creation application may be Nuance PowerScribe®, and the text report may be in the specific form of a patient medical record report such as a radiology or pathology report.

The application user then activates a message creation function, step 203, for example, by using a spoken voice command input or making a selection in a visual display using an on screen button. Specifically, the report creation application may capture report field values from various fields in the text report—e.g., patient demographic data and ordering clinician data—fill in those data values into corresponding message fields—e.g., in a report message header such as for a Veriphy™ voice message communication system. Besides the elements of the message that are populated from the text report itself, in some specific embodiments the report creation application may allow the application user to dictate additional portions to be added to the report message—e.g., to the message body. Also, one of the message fields may be a message category characterizing a report type associated with the report message.

As part of the report message creation process, an audio message attachment is extracted, step 204, from a portion of the original dictated audio input. For example, while dictating, the application user may embed one or more keywords into the spoken input which act as section markers within the report. In specific embodiments, the automatic extraction of the message audio extract may be based on user configurable settings. In one specific embodiment, the report creation application has a site level configuration parameter which can be configured with specific section names that identify sections of the report—e.g., a summary section such as an “Impression” section in a radiology report. The application user then has the option to select this feature from a message creation dialog box, which would cause the audio attachment to be automatically extracted which corresponds to the selected section of the report document.

The extracted audio is then automatically attached to the report message, step 205. With regards to the audio extraction, one embodiment based on the PowerScribe® product uses a “Section Name/Phrase” to search through the report document, and if the corresponding section is found, the system finds the section boundary (some text area X to Y) and uses audio/text concordance information to extract the corresponding audio and attach it to the body of the report message.

The report message with the message audio extract attachment is then forwarded over the electronic communication system to the message recipient, step 206. So in one specific arrangement, the report message is handed off from PowerScribe® to the Vocada Veriphy™ voice message system through a web service interface.

Embodiments of the invention may be implemented in any conventional computer programming language. For example, preferred embodiments may be implemented in a procedural programming language (e.g. “C”) or an object oriented programming language (e.g., “C++”, Python). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

What is claimed is:

1. A method of creating a voice message comprising;
converting a dictated audio input using automatic speech recognition to produce a structured text report including a plurality of report fields containing report field data extracted from the dictated audio input;
creating a report message for transmission over an electronic communication system to a message recipient, the report message including a plurality of message fields containing message field data based on corresponding report field data;
attaching to the report message a message audio extract that is automatically extracted from a portion of the dictated audio input; and
forwarding the report message with the message audio extract attachment over the electronic communication system to the message recipient.

2. A method according to claim 1, wherein the message audio extract corresponds to a summary section of the structured text report.

3. A method according to claim 2, wherein the summary section corresponds to an impression section of a radiography report.

4. A method according to claim 1, wherein the structured text report is a patient medical report.

5. A method according to claim 4, wherein the patient medical report is a patient radiography report.

6. A method according to claim 1, wherein one of the message fields is a message category characterizing a report type associated with the report message.

7. A method according to claim 1, wherein the automatic extraction of the message audio extract is based on user configurable settings.

8. A method according to claim 1, wherein creating a report message occurs in response to a spoken command input.

9. A method according to claim 1, wherein creating a report message occurs in response to a selection from a visual display.

10. A computer program product in a computer readable storage medium for creating a voice message comprising;
program code for converting a dictated audio input using automatic speech recognition to produce a structured text report including a plurality of report fields containing report field data extracted from the dictated audio input;
program code for creating a report message for transmission over an electronic communication system to a message recipient, the report message including a plurality of message fields containing message field data based on corresponding report field data;
program code for attaching to the report message a message audio extract that is automatically extracted from a portion of the dictated audio input; and
program code for forwarding the report message with the message audio extract attachment over the electronic communication system to the message recipient.

11. A computer program product according to claim 10, wherein the message audio extract corresponds to a summary section of the structured text report.

12. A computer program product according to claim 11, wherein the summary section corresponds to an impression section of a radiography report.

13. A computer program product according to claim 10, wherein the structured text report is a patient medical report.

14. A computer program product according to claim 13, wherein the patient medical report is a patient radiography report.

15. A computer program product according to claim 10, wherein one of the message fields is a message category characterizing a report type associated with the report message.

16. A computer program product according to claim 10, wherein the automatic extraction of the message audio extract is based on user configurable settings.

17. A computer program product according to claim 10, wherein program code for creating a report message is responsive to a spoken command input.

18. A computer program product according to claim 10, wherein program code for creating a report message is responsive to a selection from a visual display.
